(19) United States
(12) Patent Application Publication
(10) Pub. No.: US 2006/0282849 A1
(43) Pub. Date: Dec. 14, 2006

(54) Digital TV receiving device

(75) Inventor: Ming-Yeang Lin, Taoyuan City (TW)

Correspondence Address: TROXELL LAW OFFICE PLLC;SUITE 1404, 5205 LEESBURG PIKE, FALLS CHURCH, VA, 22041, US

(73) Assignee: UNIWILL COMPUTER CORP.

(21) Appl. No.: 11/316,714

(22) Filed: Dec. 27, 2005

(30) Foreign Application Priority Data
Jun. 10, 2005 (TW) 094209797

(51) Int. Cl. H04N 7/18; H04N 7/173; G06F 3/00; G06F 13/00; H04N 5/50; H04N 9/475; H04N 5/445

(52) U.S. Cl. 725/38; 348/510; 348/731; 725/100; 725/131; 725/80; 725/81

(57) ABSTRACT

A digital TV receiving device includes a control circuit board and a TV tuner; a built-in signal receiver in the digital TV receiving device receives AV signals transmitted by digital TV broadcasting system; the TV turner decodes and modulates those AV signals, and then transmits modulated/restored digital signals to an externally connected information host to output for presentation.

### BACKGROUND OF THE INVENTION

(a) Field of the Invention

The present invention is related to a digital video receiving technology at the viewing end of a digital video system, and more particularly, to a digital television(TV) receiving device provided with built-in signal receiver that can be adapted to an information host (e.g., flat panel computer, notebook or desktop computer).

(b) Description of the Prior Art

Digital video broadcasting for providing top picture quality, top sound quality, and value-added service derived from digital broadcasting is taking over the conventional analog system. Furthermore, inter terms of signal transmission, conventional analog system is vulnerable to poor reception at the viewing end due to interference by terrain and man-made surface features. On the contrary, signals from digital video broadcasting system transmitted via cable, satellite, microwave, and ground media provides better and more programs at the viewing end due to more efficient use of frequency spectrum.

At present, the video transmission executed by the digital TV broadcasting system is essentially done by having first the analog signals digitalized and video coded before being converged into a single information flow with other digital data to be transmitted via modular, converter and antenna. Therefore, the device at the viewing end to receive digital video signals must be capable of receiving and decoding/modulating to present on its monitor the digital TV program received.

Digital TV systems generally available in the market have a stationary digital TV receiving turner externally connected to a monitor or have a built-in digital tuner of domestic type. FIG. 1 of the accompanying drawings shows that a digital TV receiving tuner 12 is externally connected to a notebook 11. Wherein, the tuner 12 is connected to the notebook 11 with a Universal Serial Bus(USB) transmission cable 13 and an antenna 14 is externally connected to the tuner 12 to receive digital video signals and transmit the same into the turner 12 where signals are decoded/modulated before being modulated/reduced through a control circuit board for transmission to the notebook 11 via the USB transmission cable 13 for presentation. However, the antenna is externally connected to the turner and an additional transmission cable is needed for connection of the prior art present limit and inconvenience to the work environment of the user.

### SUMMARY OF THE INVENTION

The primary purpose of the present invention is to provide a digital TV receiving device that does not required additional transmission cable for connecting the antenna while maintaining the transmission results as desired.

To achieve the purpose, the present invention includes a control circuit board and a TV tuner. Wherein, a signal receiver is built in the digital TV receiving device to receive audio/video(AV) signals transmitted from a digital TV broadcasting system. Signals received are decoded/modulated with the TV tuner and the control circuit board transmits in turn the modulated/reduced digital signals to a monitor of a host for presentation.

Another purpose of the present invention is to provide a digital TV receiving device that is further integrated with a communication interface (e.g., USB interface) to become a portable digital TV receiving device with Plug-and-Play(PnP) function by connecting to an information host to receive and output for display those AV signals transmitted by the digital TV broadcasting system.

Another purpose yet of the present invention is to provide a digital TV receiving device that is further disposed with a storage object (e.g., micro-hard disk unit) and a switch for the user to select between receiving digital signals or storing data.

### BRIEF DESCRIPTION OF THE DRAWINGS

FIG. 1 is a perspective view showing a TV receiving tuner of the prior art connected to a notebook.

FIG. 2 is a perspective view showing a first preferred embodiment of the present invention.

FIG. 3 is a perspective view showing a second preferred embodiment of the present invention.

FIG. 4 is an exploded view showing a third preferred embodiment of the present invention connected to a notebook.

FIG. 5 is a block chart showing the construction of the third preferred embodiment of the present invention.

FIG. 6 is a block chart showing the construction of a fourth preferred embodiment of the present invention.

FIG. 7 is a perspective view showing the fourth preferred embodiment of the present invention connected to a notebook.

FIG. 8 is a schematic view showing a fifth preferred embodiment of the present invention.

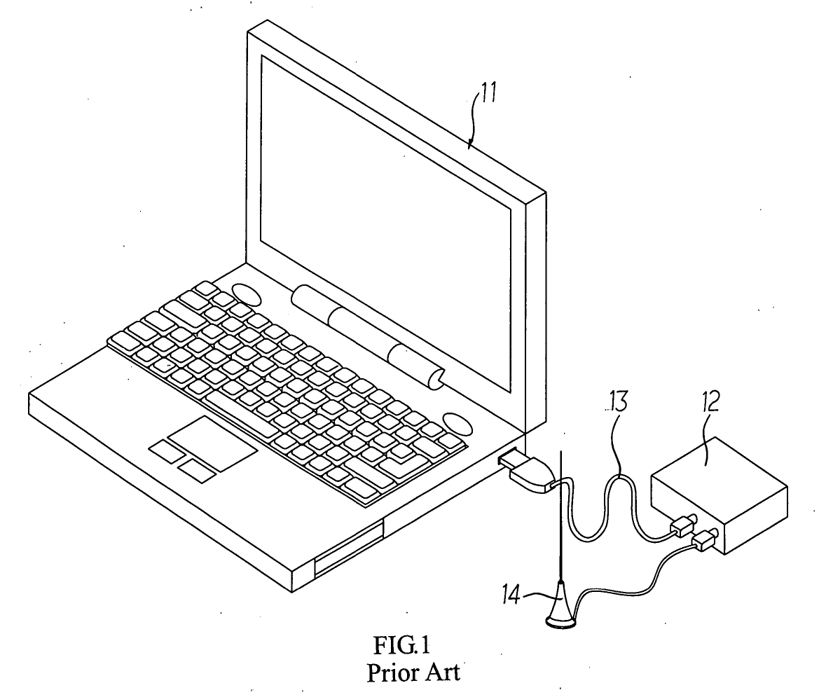

### DETAILED DESCRIPTION OF THE PREFERRED EMBODIMENTS

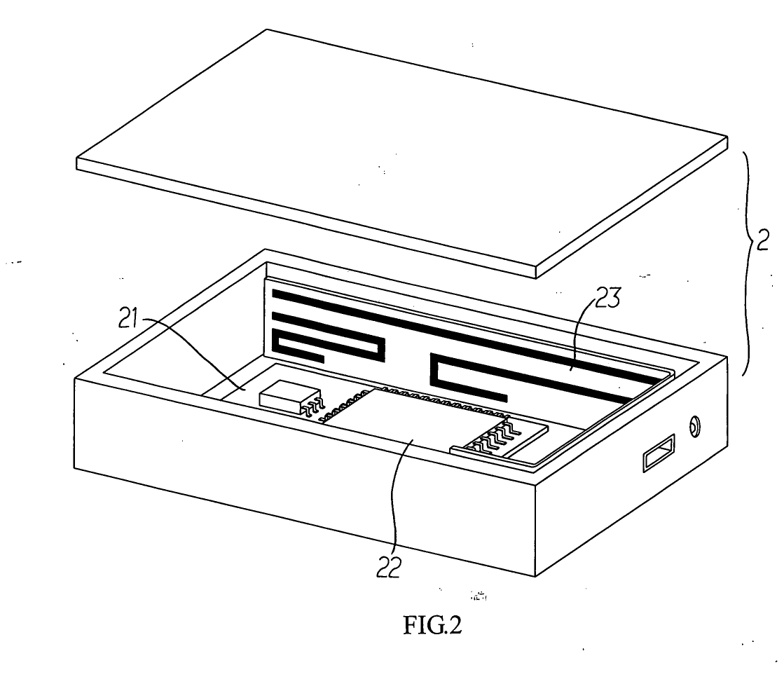

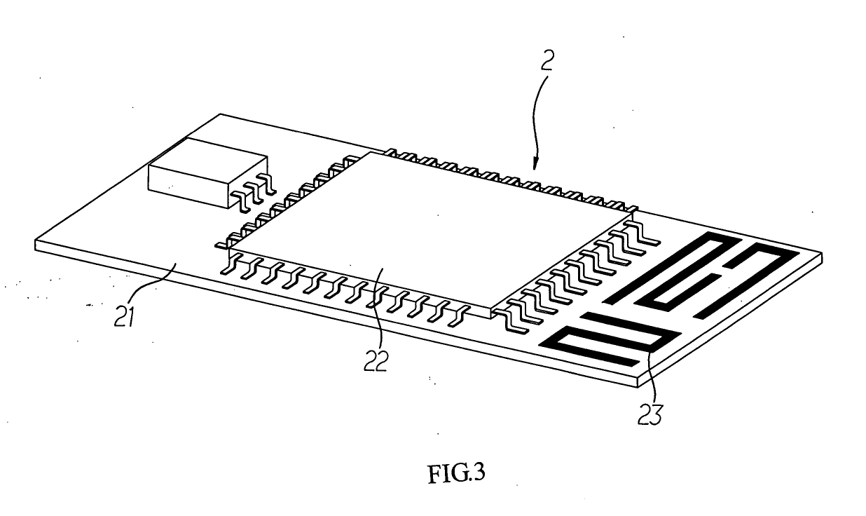

The digital TV receiving device of the present invention is made in a box type externally connected to a monitor as illustrated in FIG. 2 or in a circuit board adapted in the monitor as illustrated in FIG. 3. In either form, a digital TV receiving device 2 of the present invention is essentially comprised of a control circuit board 21 and a TV tuner 22. A signal receiver 23 directly printed on a micro-ban antenna as illustrated in FIG. 2 on a flexible circuit board or on a flat antenna as illustrated in FIG. 3 of the control circuit board 21.

The signal receiver 23 receives signals transmitted form a digital TV broadcasting system and the TV tuner 22 decodes/modulates those signals received. In the preferred embodiment, the TV tuner 22 relates to the comparatively popular Advanced Television System Committee(ATSC, USA specifications), Digital Video Broadcast-Terrestrial(DVB-T, European specifications), Digital Video Broadcast-Cable(DVB-C) or Digital Video Broadcast-Handheld(DVB-H) standard tuner. The control circuit board 21 provides for the monitor of an information host a corresponding signal transmission interface (e.g., a USB interface) and transmits modulated and reduced digital signals to the monitor of the information host for presentation.

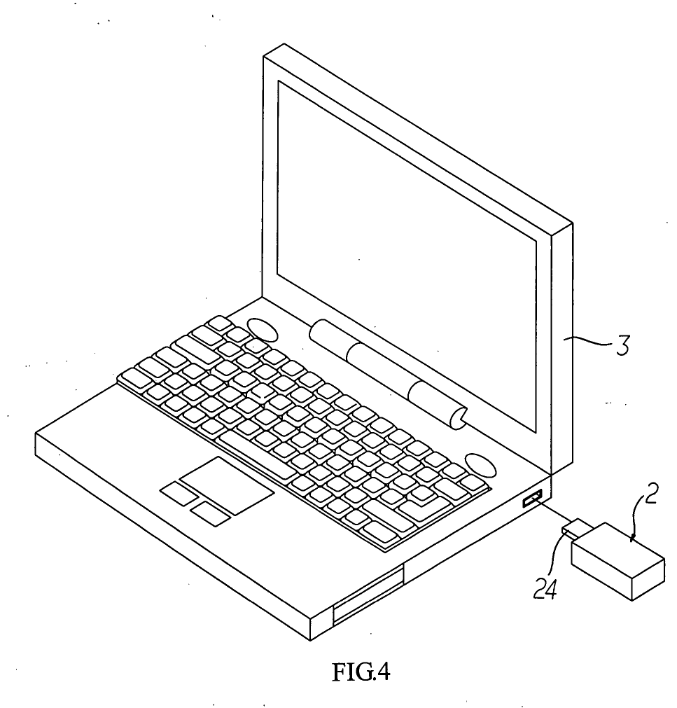

Now referring to FIGS. 4 and 5 for a third preferred embodiment of the present invention, a communication interface 24 is built in the digital TV receiving device 2 for it to become a portable digital TV receiving device. Once those digital AV signals are received by the signal receiver 23, they are decoded/modulated with the TV tuner 22 for output through the communication interface 24 to display on a monitor 3.

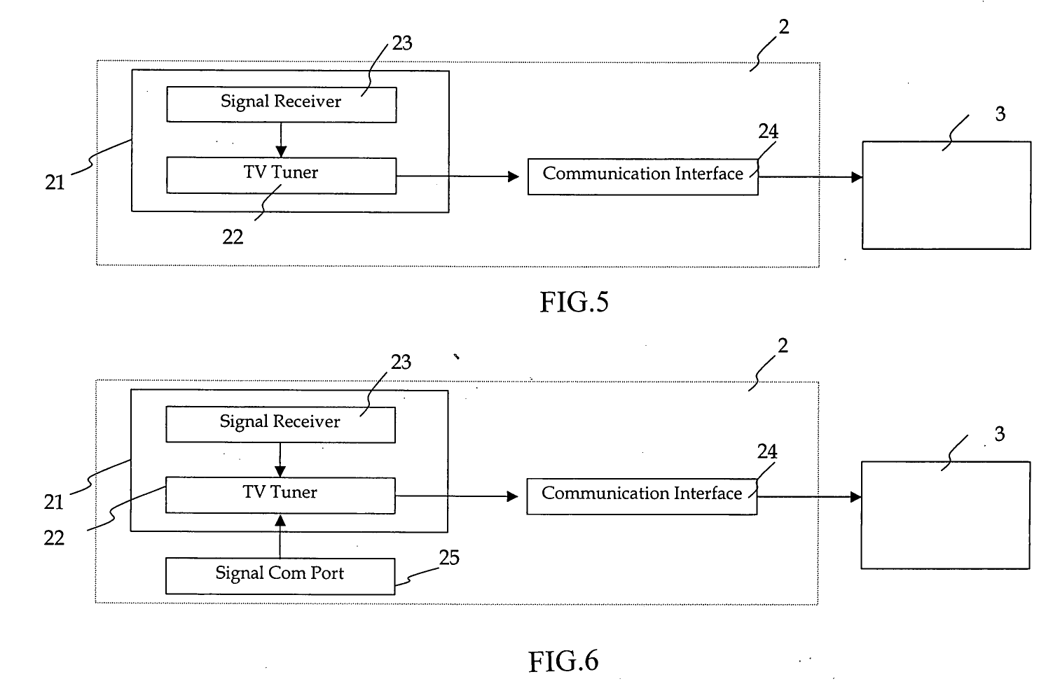

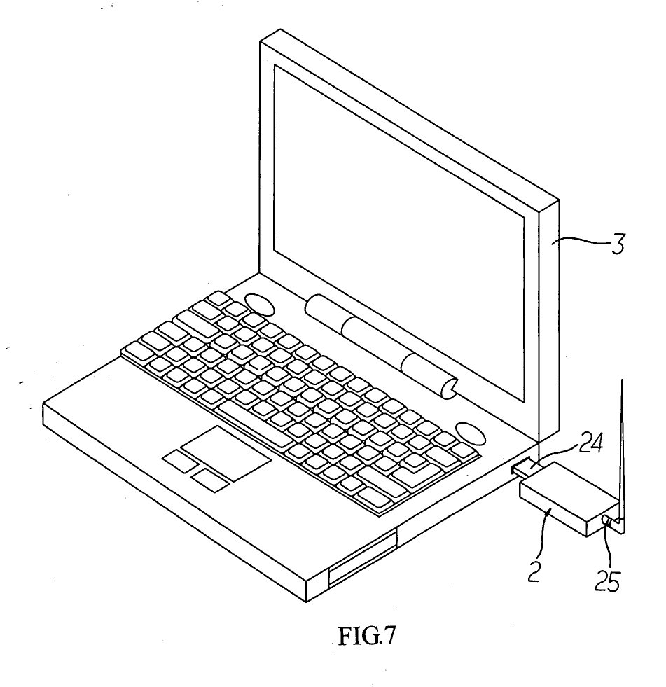

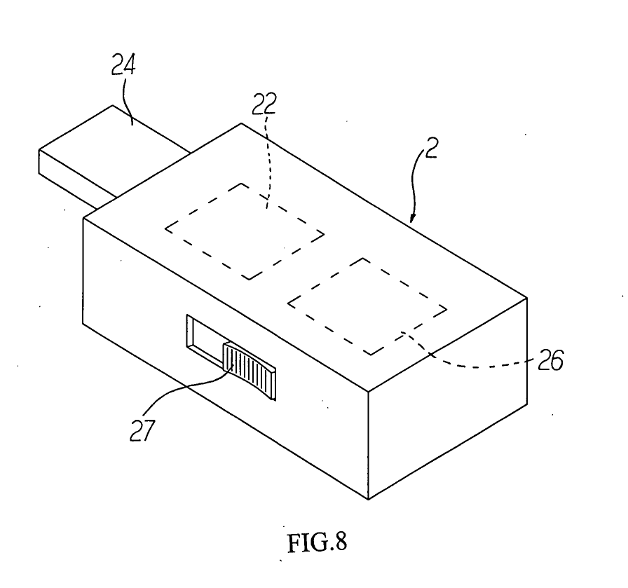

As illustrated in FIG. 6 for a fourth preferred embodiment of the present invention, a signal communication port 25 is further disposed to the digital TV receiving device 2 for the installation of another antenna as illustrated in FIG. 7 to expand the signal receiving range and reduce signal blind angle thus to upgrade the quality of signals received.

In a fifth preferred embodiment of the present invention as illustrated in FIG. 8, the digital TV receiving device 2 is integrated with the control circuit board 21, the TV tuner 22, the signal receiver 23, the storage object 26, and the switch 27. Wherein, the switch 27 may be of an electronic switch or one program controlled.

The signal receiver 23 relates to a built-in antenna to receive signals transmitted from the digital TV broadcasting system. The signal receiver 23 built in the digital TV receiving device may be made in a form of a micro-ban antenna or a flat antenna. The TV tuner 12 decodes/modulates the signals received. The control circuit board 21 transmits the modulated and reduced digital signals to the monitor of the information host for presentation. The storage object 26 is related to a flash memory or a micro-hard disk unit to store data as desired. A communication interface 24 is further provided to the digital TV receiving device 2 for the switch to choose between functions of viewing the digital signals receiver or storing data. If the former is selected to view the digital program transmitted from the digital TV broadcasting device, the digital TV receiving device is switched to receive and display AV signals on the monitor of the information host (e.g., flat panel computer, notebook or desktop computer); or alternatively, if the latter is selected for data transmission, the digital TV receiving device is switched to a data access module to execute data storage with the storage object and the information host.

The prevent invention provides an improved construction of a digital TV receiving device, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A digital TV receiving device includes a control circuit board and a TV tuner; wherein, a signal receiver is built in the digital TV receiving device to receive signals transmitted from a digital TV broadcasting system; and the TV tuner decodes/modulates those signals received.

2. The digital TV receiving device of claim 1, wherein a communication interface is further provided to send digital signals to an information host.

3. The digital TV receiving device of claim 1, wherein the signal relates to a micro-band antenna.

4. The digital TV receiving device of claim 1, wherein the signal receiver relates to a flat antenna.

5. The digital TV receiving device of claim 1, wherein a signal communication port is further provided for the installation of another antenna.

6. The digital TV receiving device of claim 2, wherein the communication interface relates to a USB interface.

7. The digital TV receiving device of claim 2, wherein the information host relates to a flat panel computer, a notebook or a desktop computer.

8. The digital TV receiving device of claim 2, wherein a storage object is further provided.

9. A digital TV receiving device includes a control circuit board to control the operation of the digital TV receiving device; a signal receiver built in the digital TV receiving device to receive signals transmitted from a digital TV broadcasting system; a TV tuner to decode/modulate those signals received; a storage object to store data; and a switch to select for the signal receiver to receive digital signals or for the storage object to store data.

10. The digital TV receiving device of claim 9, wherein a communication interface is further provided to transmit digital signals to an information host.

11. The digital TV receiving device of claim 9, wherein the signal receiver relates to a micro-band antenna.

12. The digital TV receiving device of claim 9, wherein the signal receiver relates to a flat antenna.

13. The digital TV receiving device of claim 9, wherein a signal communication port is further provided for the installation of another antenna.

14. The digital TV receiving device of claim 9, wherein the storage medium relates to flash memory.

15. The digital TV receiving device of claim 10, wherein the communication interface relates to a USB interface.

16. The digital TV receiving device of claim 10, wherein the information host relates to a flat panel computer, a notebook or a desktop computer.

17. The digital TV receiving device of claim 10, wherein the switch is related to an electronic switch or a program controlled switch.
